(19) United States
(12) Patent Application Publication
(10) Pub. No.: US 2012/0229520 A1
(43) Pub. Date: Sep. 13, 2012

(54) MOBILE ELECTRONIC DEVICE

(75) Inventors: Keiko MIKAMI, Osaka (JP); Toshihiro KAMII, Osaka (JP)

(73) Assignee: KYOCERA CORPORATION, Kyoto (JP)

(21) Appl. No.: 13/416,266

(22) Filed: Mar. 9, 2012

(30) Foreign Application Priority Data
Mar. 11, 2011 (JP) 2011-054686

(51) Int. Cl. G09G 5/30

(52) U.S. Cl. 345/676

(57) ABSTRACT

A mobile electronic device and methods are disclosed. A first and second input on a first and second display is detected. A cancellation screen comprising a first object image for cancelling a key lock function that sets the first and second input to invalid inputs is displayed. A position of the first object image is moved in response to one of the first and second input. The key lock function is cancelled, if the position of the first object image is moved from the first display to the second display.

### CROSS-REFERENCE TO RELATED APPLICATION

The present application claims priority under 35 U.S.C. §119 to Japanese Patent Application No. 2011-054686, filed on Mar. 11, 2011, entitled “MOBILE TERMINAL DEVICE”. The content of which is incorporated by reference herein in its entirety.

### FIELD

Embodiments of the present disclosure relate generally to mobile electronic devices, and more particularly relate to mobile electronic device comprising multiple displays.

### BACKGROUND

Some mobile phones comprise a key-lock function that disables inputs received from key buttons or touch panels. An activated key-lock function can be deactivated by pressing a predefined key button for more than a predefined period. However, key buttons may be unintentionally touched and deactivated by objects near the mobile phone such as objects placed inside a bag.

### SUMMARY

A mobile electronic device and methods are disclosed. A first and second input on a first and second display is detected. A cancellation screen comprising a first object image for cancelling a key lock function that sets the first and second input to invalid inputs is displayed. A position of the first object image is moved in response to one of the first and second input. The key lock function is cancelled, if the position of the first object image is moved from the first display to the second display.

In this manner, key buttons may be not be unintentionally touched by objects near the mobile phone such as objects placed inside a bag. Thereby, malfunctions may be prevented in accordance with an intention by the user.

In an embodiment, a mobile electronic device, comprises a display control module to control a first display module and a second display module to detect a first input and a second input respectively. The display control module also displays a cancellation screen comprising a first object image for cancelling a key lock function, and moves a first image position of the first object image in response to one of the first input and the second input. The mobile electronic device also comprises a function control module to control a setting and a cancellation of the key lock function that sets the first input and the second input to invalid inputs.

The function control module further cancels the key lock function, if the display control module moves the first image position from the first display module to the second display module.

In another embodiment, a method for controlling a mobile electronic device detects a first input and a second input on a first display module and a second display module respectively. The method then displays a cancellation screen comprising a first object image for cancelling a key lock function that sets the first input and the second input to invalid inputs and moves a position of the first object image in response to one of the first input and the second input.

The method further, cancels the key lock function, if the first image position of the first object image is moved from the first display module to the second display module.

In a further embodiment, a computer readable storage medium comprising computer-executable instructions for operating a mobile electronic device detects a first input and a second input on a first display module and a second display module respectively. The method executed by the computer-executable instructions further displays a cancellation screen comprising a first object image for cancelling a key lock function that sets the first input and the second input to invalid inputs. The method executed by the computer-executable instructions further moves a position of the first object image in response to one of: the first input and the second input.

The method executed by the computer-executable instructions further cancels the key lock function, if the first image position of the first object image is moved from the first display module to the second display module.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1 is an illustration of an exemplary mobile phone according to an embodiment of the disclosure.

FIGS. 2A to 2D are illustrations of the mobile phone shown in FIG. 1 showing a switching operation from a closed state to an open state according to an embodiment of the disclosure.

FIG. 3 is an illustration of an exemplary functional block diagram of a mobile phone according to an embodiment of the disclosure.

FIGS. 4A and 4B are diagrams displaying a cancellation screen on each display surface according to an embodiment of the disclosure.

FIG. 5 is an illustration of a flowchart showing a process in which a key lock function is cancelled if an operation is carried out such that a display position of an object image is moved to the second display surface according to an embodiment of the disclosure.

FIG. 6 is an illustration of a flowchart showing process in which a key lock function is cancelled if a display position of an object image at a time of release is on a second display surface according to an embodiment of the disclosure.

FIG. 7 an illustration of a flowchart showing a process in which a key lock function is cancelled if a display region of an object image is on a second display surface for more than a predefined time according to an embodiment of the disclosure.

FIG. 8 an illustration of a flowchart showing a process in which a key lock function is cancelled if a display region of an object image is in a same position on a second display surface for more than a predefined time an embodiment of the disclosure.

FIGS. 9A and 9B are diagrams displaying a cancellation screen on each display surface an embodiment of the disclosure.

FIGS. 10A and 10B are diagrams displaying a cancellation screen on each display surface according to an embodiment of the disclosure.

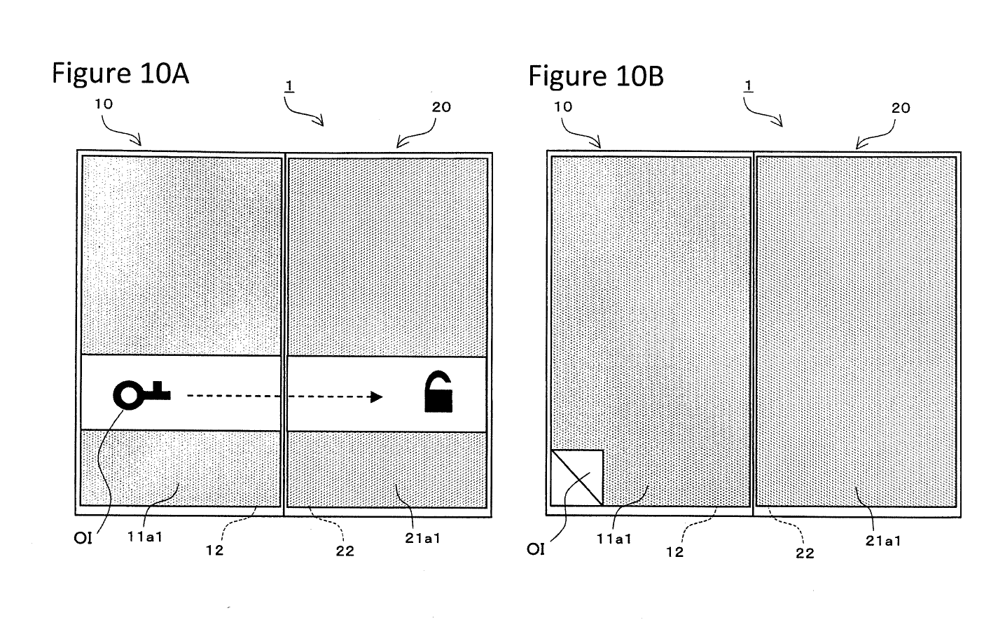

FIG. 11 is a diagram displaying a cancellation screen on each display surface according to an embodiment of the disclosure.

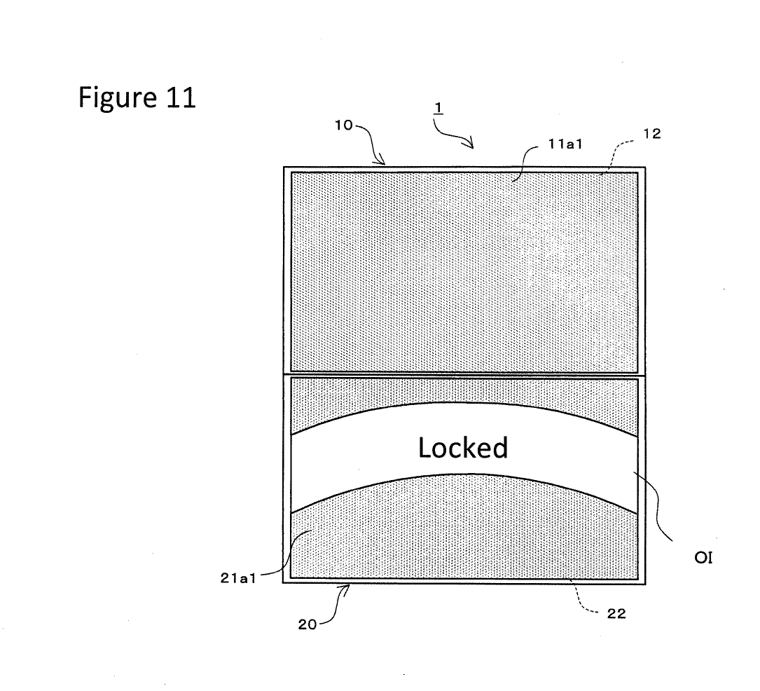

FIGS. 12A and 12B are diagrams displaying a cancellation screen on each display surface in a portrait orientation according to an embodiment of the disclosure.

FIG. 13 is a diagram displaying a cancellation screen on each display surface of in a landscape orientation according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, a mobile electronic device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, TV's, e-books, Global Positioning Systems (GPSs) or navigation systems, pedometers, health equipment, display monitors, or other electronic device that uses a display screen or a touch panel for displaying information.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

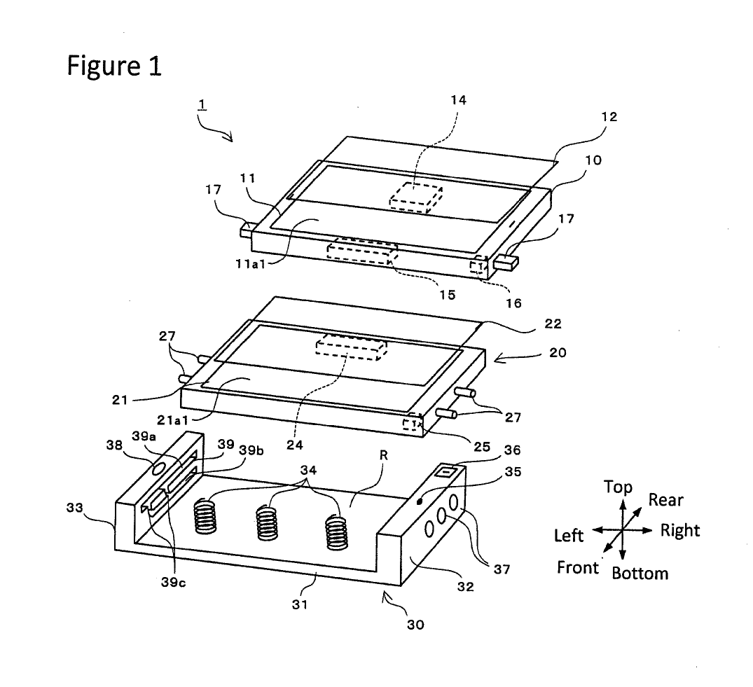

FIG. 1 is an illustration of an exemplary mobile phone 1 according to an embodiment of the disclosure. Specifically, FIG. 1 is an exploded perspective view showing the configuration of a mobile phone 1. The mobile phone 1 comprises a first cabinet 10, a second cabinet 20, and a support 30 that retains this first cabinet 10 and second cabinet 20.

The first cabinet 10 has a landscape-oriented rectangular shape. A first touch panel is disposed on the front side of the first cabinet 10. The first touch panel comprises a first display 11 and a first touch sensor 12.

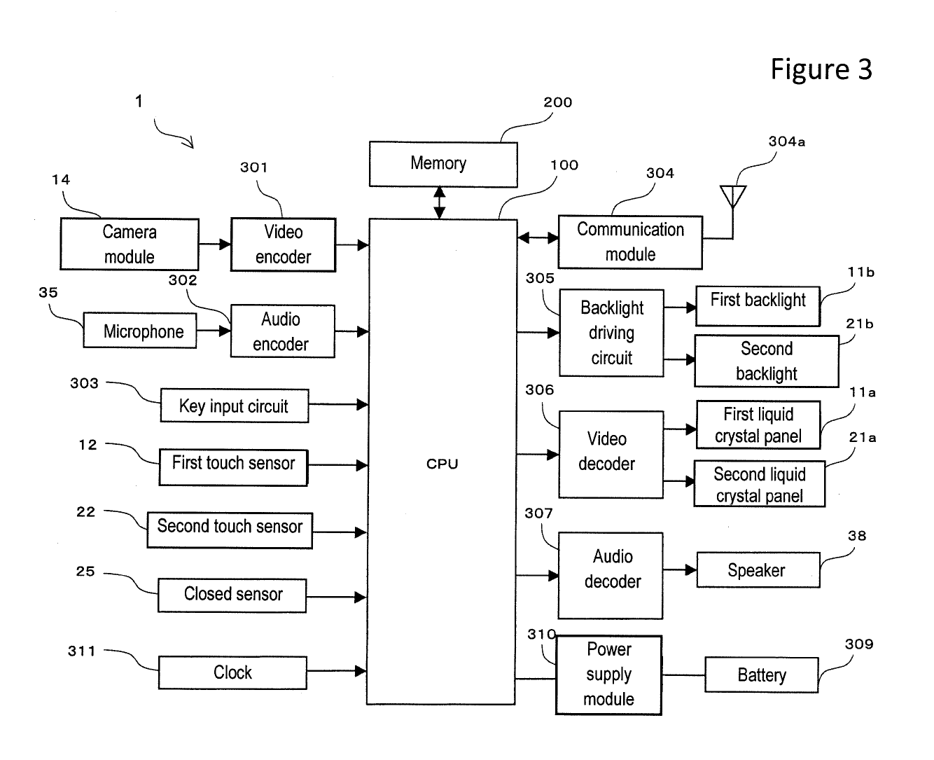

The first display 11 is equivalent to a display module that displays images on a first display surface (11a1). The first display 11 comprises a first liquid crystal panel 11a and a first backlight 11b (refer to FIG. 3). The first display surface 11a1 is provided on the front surface of the first liquid crystal panel (11a). The first touch sensor 12 is stacked on top of the first display surface (11a1). The first backlight 11b comprises either one or a plurality of light sources and lights up the first liquid crystal panel (11a).

The first touch sensor 12 is equivalent to a detection module that detects inputs with respect to the first display (11). The first touch sensor 12 is a transparent rectangular shaped sheet and covers the first display surface 11a1 of the first display (11). The first touch sensor 12 comprises a first transparent electrode and a second transparent electrode disposed in a matrix shape. The first touch sensor 12 detects the position on top of the first display surface 11a1 touched by a user by detecting changes in capacitance between these transparent electrodes and outputs the position signals.

For example, what is meant by the user touching the first display surface 11a1 refers to the user touching the first display surface 11a1 using a contact-carrying member such as a pen. The contact-carrying member or finger that touched the first display surface 11a1 may remain still or it may be moved. A time during which the contact-carrying member or the finger touches the first display surface 11a1 may be short or it may be long.

The first cabinet 10 comprises a camera module 14 in the middle and slightly toward the rear position of the inside thereof. The first cabinet 10 also comprises a lens window (not shown in the figure) on a bottom surface thereof to take in a subject image in the camera module 14.

The first cabinet 10 comprises a magnet 15 and a magnet 16. The first cabinet comprises the magnet 15 in the middle position in the vicinity of the front surface thereof and the magnet 16 at a right front corner thereof.

The first cabinet 10 comprises a protruding member 17. The first cabinet 10 comprises the protruding member 17 on a right side and on a left side thereof.

The second cabinet 20 has a landscape-oriented rectangular shape and is of nearly the same shape as the first cabinet 10. A second touch panel is disposed in the second cabinet 20. The second touch panel comprises a second display 21 and a second touch sensor 22.

The second display 21 is equivalent to a display module that displays images on a second display surface 21a1. The second display 21 comprises a second liquid crystal panel 21a and a second backlight 21b (refer to FIG. 3). The second display surface 21a1 is provided on the front surface of the second liquid crystal panel 21a. The second backlight 21b comprises either one or a plurality of light sources and lights up the second liquid crystal panel 21a. Note that the first display 11 and the second display 21 may be configured by other display elements such as organic electro-luminescence (OEL).

The second touch sensor 22 is equivalent to a detection module that detects inputs with respect to the second display 21. The second touch sensor 22 may be of a similar shape and configuration as the first touch sensor 12. The second touch sensor 22 covers the second display surface 21a1 of the second display 21, detects the position on top of the second display surface 21a1 touched by the user, and outputs position signals corresponding to this input position.

The second cabinet 20 comprises a magnet 24. The second cabinet 20 comprises the magnet 24 in the middle position in the vicinity of the rear surface thereof. The magnet 24 and the magnet 15 in the first cabinet 10 are configured to attract each other in an open state explained below.

The second cabinet 20 comprises a closed sensor 25. The second cabinet 20 comprises the closed sensor 25 at a right front corner. The closed sensor 25 comprises, for example, but without limitation, a Hall effect integrated circuit (IC) or other sensor and outputs sensor signals when detecting the magnetic force of the magnet 16. In a closed state explained below, the magnet 16 in the first cabinet 10 approaches closely to the closed sensor 25. Thus, the closed sensor 25 detects the magnetic force of the magnet 16 and outputs sensor signals to a CPU 100 (FIG. 3). On the other hand, in an open state, the magnet 16 in the first cabinet 10 moves away from the closed sensor 25. The closed sensor 25 does not output sensor signals to the CPU 100 because the closed sensor 25 does not detect the magnetic force of the magnet 16.

The second cabinet 20 comprises two shanks 27 respectively on the both side surfaces thereof.

The supporter 30 comprises a base plate module 31, a right holding module 32 located at a right edge of the base plate module 31, and a left holding module 33 located at a left edge of the base plate module 31.

On the base plate module 31, three coil springs 34 are horizontally arranged side by side in a direction from right to left. Since the second cabinet 20 is fixed in the supporter 30, the coil springs 34 come in contact with the bottom surface of the second cabinet 20 and provide the force to push the second cabinet 20 upward.

A microphone 35 and a power key 36 are located on the top surface of the right holding module 32. A speaker 38 is located on the top surface of the left holding module 33. A plurality of hard keys 37 is located on the outside side surfaces of the right holding module 32.

The right holding module 32 and the left holding module 33 comprise guide grooves 39 on the inside side surfaces thereof (inside side surface of the left holding module 33 shown in FIG. 1). A guide groove 39 comprises an upper groove 39a, a lower groove 39b, and two vertical grooves 39c. The upper groove 39a and the lower groove 39b are extended in a longitudinal direction or in a direction from front to rear, and the vertical grooves 39c are extended in the vertical direction or in a direction from top to bottom for connecting the upper groove 39a and the lower groove 39b.

When the mobile phone 1 is assembled, the shanks 27 are inserted into the lower grooves 39b of the guide grooves 39. The second cabinet 20 is housed in the housing area R of the supporter 30. The protruding members 17 are inserted into the upper grooves 39a of the guide grooves 39. The first cabinet 10 is disposed on top of the second cabinet 20 and housed in the housing area R of the supporter 30.

Thus, the first cabinet 10 and the second cabinet 20 are housed one above the other in the housing area R surrounded by the base plate module 31, the right holding module 32, and the left holding module 33. In this configuration, the first cabinet 10 may slide back and forth guided by the upper grooves 39a. The second cabinet 20 may slide back and forth guided by the lower grooves 39b. When the second cabinet 20 moves forward, and when the shanks 27 reach the vertical grooves 39c, the second cabinet 20 may slide up and down guided by the vertical grooves 39c.

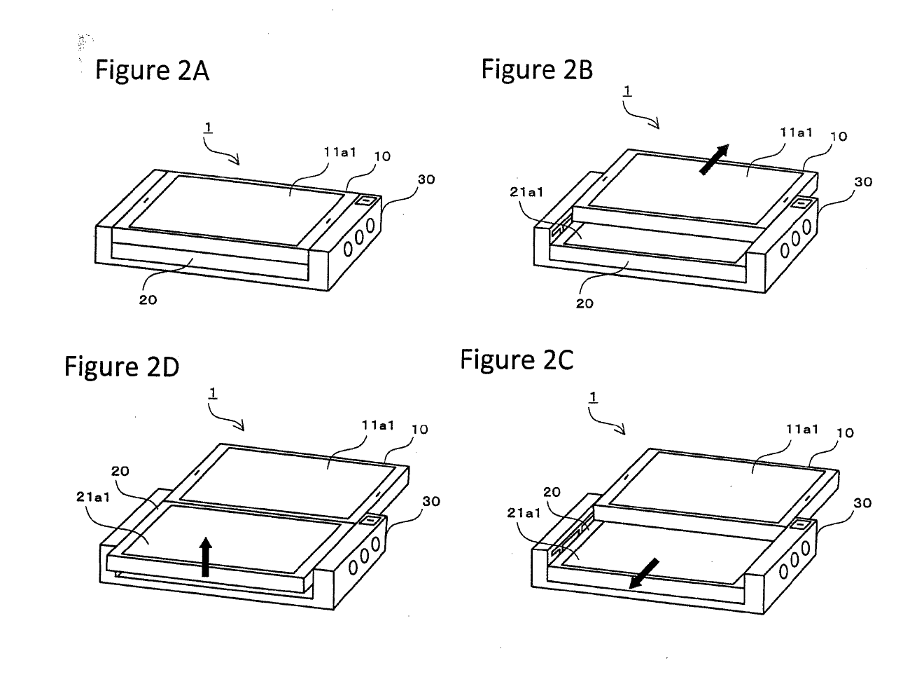

FIGS. 2A to 2D are illustrations of the mobile phone 1 shown in FIG. 1 showing a switching operation from a closed state to an open state according to an embodiment of the disclosure. The first cabinet 10 is superimposed on top of the second cabinet 20 in the closed state shown in FIG. 2A. The closed state corresponds to a first configuration in which the second display surface 21a1 is covered with the first cabinet 10. In the closed state, only the first display surface 11a1, among the first display surface 11a1 and the second display surface 21a1, is exposed outside.

The first cabinet 10 moves in a direction of an arrow shown in FIG. 2B, and the second cabinet 20 moves in a direction of an arrow shown in FIG. 2C. Thus, when the closed sensor 25 no longer detects the magnetic force of the magnet 16 and no longer outputs sensor signals, the mobile phone 1 is switched to an open state. In the open state, at least a part of the second display surface 21a1 is exposed outside.

When the second cabinet is no longer substantially completely overlapped with the first cabinet 10, the shanks 27 shown in FIG. 1 reach the vertical grooves 39c. Thus, the shanks 27 move along the vertical grooves 39c, and the cabinet 20 is able to move up and down. In this manner, the second cabinet 20 moves upward due to the elastic force of the coil springs 34 and the attracting force of the magnet 15 and the magnet 24.

As shown in FIG. 2D, the second cabinet 20 and the first cabinet 10 are aligned and in contact with each other, and the second display surface 21a1 becomes as high as the first display surface (11a1). Hence, the first display surface 11a1 and the second display surface 21a1 are both exposed outside.

Furthermore, as shown in FIG. 2B through FIG. 2D, an open state corresponds to a second configuration in which at least a part of the second display surface 21a1 is exposed outside.

The protruding members 17 move along the upper grooves 39a of the guide grooves 39, and the shanks 27 move along the lower grooves 39b, the vertical grooves 30c, and the upper grooves 39a; a closed state and an open state are switched. Therefore, the protruding members 17, the shanks 27, and the guide grooves 39 correspond to a mechanical section that connects the first cabinet 10 (first housing 10) and the second cabinet 20 (second housing 20) and enables to switch the closed sate and the open state.

FIG. 3 is a block diagram showing the electrical configuration of the mobile phone 1. In addition to each constituent element described above, the mobile phone 1 according to the present embodiment comprises a CPU 100, a memory 200, a video encoder 301, an audio encoder 302, a key input circuit 303, a communication module 304, a backlight driving circuit 305, a video decoder 306, an audio decoder 307, a battery 309, a power supply module 310, and a clock 311.

A camera module 14 comprises an image pickup device such as a charge-coupled device (CCD). The camera module 14 digitizes the imaging signals output from the image pickup device and outputs them to the video encoder 301 after performing various corrections such as gamma corrections with respect to these imaging signals. The video encoder 301 performs encoding processing with respect to the imaging signals from the camera module 14 and outputs them to the CPU 100.

A microphone 35 converts collected sound into audio signals and outputs them to the audio encoder 302. The audio encoder 302 converts the analog audio signals from the microphone 35 into digital audio signals while simultaneously performing encoding processing with respect to the digital audio signals and outputs them to the CPU 100.

When a power key 36 or any hard key 37 is pressed, the key input circuit 303 outputs the input signals corresponding to each key to the CPU 100.

The communication module 304 converts data from the CPU 100 into wireless signals and transmits them to the base station through an antenna 304a. The communication module 304 converts the wireless signals received through the antenna 304a into data and outputs this data to the CPU 100.

The backlight driving circuit 305 supplies the driving signals corresponding to the controls signals from the CPU 100 to the first backlight 11b and the second backlight 21b. The first backlight 11b is turned on by means of the driving signals by the backlight driving circuit 305 and lights up the first liquid crystal panel 11a. The second backlight 21b is turned on by means of the driving signals by the backlight driving circuit 305 and lights up the second liquid crystal panel 21a.

The video decoder 306 converts image data from the CPU 100 into video signals that can be displayed on the first liquid crystal panel 11a and the second liquid crystal panel 21a and outputs them to the liquid crystal panels 11a, 21a. The first liquid crystal panel 11a displays the first screen corresponding to the video signals on the first display surface 11a1. The second liquid crystal panel 21a displays the second screen corresponding to the video signals on the second display surface 21a1.

The audio decoder 307 performs decoding processing on the audio signals from the CPU 100 as well as the tone signals of various notification sounds such as a ringtone and alarm sound, converts them into analog audio signals, and outputs them to a speaker 38. The speaker 38 plays the tone signals or the audio signals from the audio decoder 307.

The battery 309 supplies power to the CPU 100 as well as each section besides the CPU 100, and comprises a secondary battery. The battery 309 is connected to the power supply module 310.

The power supply module 310 converts the voltage of the battery 309 to the voltage necessary for each section and supplies it to each section. The power supply module 310 supplies power through an external power supply (not shown in the figures) to the battery 309 and charges the battery 309.

The clock 311 measures time and outputs the signals in accordance with the measured time to the CPU 100.

The memory 200 may be any suitable data storage area with suitable amount of memory that is formatted to support the operation of an electronic device such as the mobile phone 1. The memory 200 is configured to store, maintain, and provide data as needed to support the functionality of the mobile phone 1 in the manner described below. In practical embodiments, the memory 200 may comprise, for example but without limitation, a non-volatile storage device (non-volatile semiconductor memory, hard disk device, optical disk device, and the like), a random access storage device (for example, SRAM, DRAM), or any other form of storage medium known in the art.

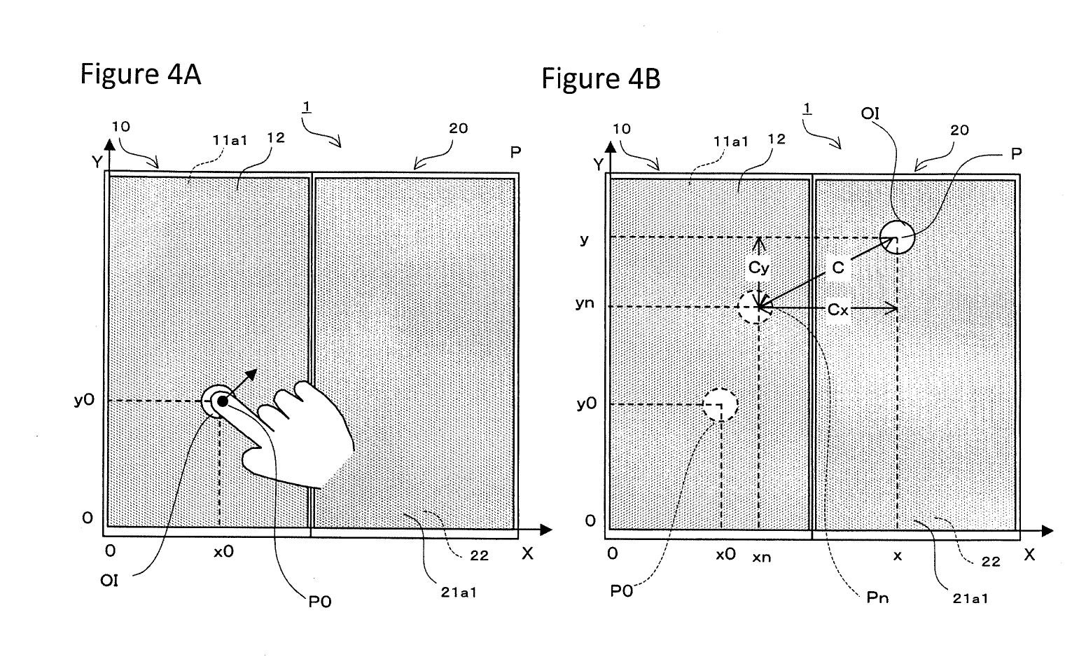

The memory 200 stores a control program for providing the CPU 100 with a control function. The control program comprises a control program in which the key lock function is cancelled if inputs are detected that move a display position P (FIG. 4B) of an object image OI to the display surface, which is different from the display surface on which the start position P0 of the object image OI is displayed.

The imaging data taken by means of the camera module 14, data acquired from outside through the communication module 304, and data input from each touch sensor 12, 22 are stored in the memory 200 in a predefined file format. The imaging data of the screen for cancelling the key lock function, described subsequently (hereinafter referred to as a “cancellation screen”), is stored in the memory 200. The start position P0 of the object image OI comprised in the cancellation screen is also stored in the memory 200.

A manipulated variable-moving distance support information are stored in the memory 200. In the manipulated variable-moving distance support information, the manipulated variable carried out by the user before release is associated with the amount by which the object image OI moves after release. The manipulated variable by the user refers to the moving speed of the object image OI in the input position before the user releases their finger and the like, from the object image OI (hereinafter referred to as “the moving speed of the input position”), for cases in which the user flicks the object image OI displayed on the display surface 11a1 or the display surface 21a1 with their finger and the like.

The movement amount of the object image OI on the cancellation screen indicates the speed at which the object image OI moves after release and a distance C. The release comprises an operation in which for cases in which the finger and the like, is brought in contact with the first display surface 11a1 or the second display surface 21a1, the finger and the like, is released from the display surface that the finger touches. The flick comprises an operation in which the finger and the like, brought in contact with the first display surface 11a1 or the second display surface 21a1 is released after it is moved on top of the display surface while maintaining the touched state. A slide comprises an operation in which the finger and the like, brought in contact with the first display surface 11a1 or the second display surface 21a1 is moved on top of the display surface while maintaining the touched state.

If the object image OI is touched by the user, an input position is acquired for each predefined time after the input position matches the start position P0 of the object image OI, and this input position is temporarily stored in the memory 200. Therefore, after release, the input position before release is read from the memory 200 and the moving speed of the input position before release is determined from the input position at each predefined time. Note that the moving speed may be calculated as the moving speed using all or a part of the input position for each predefined time stored in the memory 200. For cases in which release is detected, the moving speed may be calculated based on a first input position stored immediately before release is detected as well as based on a second input position stored before the predefined time of the first input position.

The manipulated variable—the moving distance support information may be a table in which the moving speed of the input position is associated with the moving speed of the object image OI and the moving distance C. The manipulated variable-moving distance support information may be an arithmetic expression for calculating the moving speed of the object image OI and the moving distance C from the moving speed of the input position.

In the manipulated variable-moving distance support information, the larger the moving speed of the input position, the quicker and the longer distance the object image OI is set to move. Accordingly, the quicker the user moves the finger touching both display surfaces 11a1, 21a1, the more quickly and the longer distance the object image OI moves.

The CPU 100 is configured to support functions of an electronic device such as the mobile phone 1. The CPU 100 may control operations of the mobile phone 1 so that processes of the mobile phone 1 are suitably performed. For example, the CPU 100 operates the camera module 14, the microphone 35, the communication module 304, the liquid crystal panels 11a, 21a, the speaker 38, the speaker 38 and the like, according to the control program based on operation input signals from the key input circuit 303 and each touch sensor 12, 22. The CPU 100 can accordingly execute various applications such as a communication function, an e-mail function, a power saving function, and the keylock function.

The CPU 100, may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

As a display control module, the CPU 100 outputs control signals to the video decoder 306 and the backlight driving circuit 305. For example, the CPU 100 can turn off the first backlight 11b or the second backlight 21b by controlling the backlight driving circuit 305. In contrast, the CPU 100 can display images on each display surface by turning on each backlight and controlling the video decoder 306. The CPU 100 can also control contrast, brightness, screen size, transparency of the screen and the like, when displaying images on each display surface.

For example, if the key lock function is set, the CPU 100 reads out the image data on the cancellation screen from the memory 200 and displays the cancellation screen on the first display surface 11a1 and the second display surface 21a1. If the first display surface 11a1 or the second display surface 21a1 is touched or if the hard keys 37 are pressed in the state in which each backlight 11b, 21b is turned off after the key lock function is set, the cancellation screen is displayed.

The cancellation screen comprises the object image OI. FIG. 4 is a diagram displaying the cancellation screen according to the embodiment on each display surface. One object image OI is disposed in the previously defined start position P0 on the cancellation screen. On the cancellation screen, the display coordinate system of the first display surface 11a1 and the display coordinate system of the second display surface 21a1 are common and the coordinate axis X of the first display surface 11a1 continues with the coordinate axis X of the second display surface 21a1.

The object image OI is moved if the user slides or flicks it. For example, if an operation is performed such that the object image OI is moved from the start position P0 for more than the predefined distance of, for example, 320 px in the predefined time of 0.2 seconds, it is determined that a flick is performed. If an operation is performed such that the object image OI is moved from the start position P0 for more than the predefined distance of 320 px for longer than the predefined time of 0.2 seconds, it is determined that a slide is performed.

While position signals are output from the first touch sensor 12 or the second touch sensor 22 to the CPU 100 as the user slides the finger touching the object image OI, the display position P of the object image OI is aligned to the input position of the position signals. Accordingly, the object image OI is displayed in the input position touched by the user and the display position P of the object image OI is moved according to the transition of the input position of the position signals output from each touch sensor.

When the finger touching the object image OI moves from the first display surface 11a1 to the second display surface 21a1, there is a time in which the position signals are not output from either one of the touch sensors to the CPU 100 between the time in which the position signals are no longer output from the first touch sensor 12 to the time in which the position signals are output from the second touch sensor 22.

If this time is less than the predefined time, the CPU 100 may determine that the operation moving the object image OI continues. In contrast, if this time is more than the predefined time, the CPU 100 may determine that the finger touching the object image OI has been released. If it is determined by the CPU 100 that the finger has been released, the CPU 100 displays the object image OI in the start position P0.

If the finger touching the object image OI is released from the display surface by means of a flick, the CPU 100 determines the moving speed of the object image OI and the moving distance C from the moving speed of the input position before release based on the manipulated variable-moving distance support information of the memory 200. Accordingly, the CPU 100 object displays the movement of the object image OI in the display manner so as to be moving at the moving speed that determines the distance between a display position Pn and the moving distance C at the time of release.

If the key lock function is cancelled, the CPU 100 displays the operation screen, in place of the cancellation screen, on each display surface. The operation screen may be displayed after the predefined time once it is determined that the key lock function is cancelled. The operation screen may be the previously defined screen or it may be the screen the user operates before setting the key lock function.

If the power saving function is started, the CPU 100 turns off each backlight 11b, 21b. For example, if the time elapsed since the input signals from each touch sensor and the key input circuit 303 disappear exceeds the predefined time, the power saving function is set and each backlight 11b, 21b is turned off. If the hard keys 37 to which processing that sets the power saving function is allocated is operated, the power saving function is set and each backlight 11b, 21b is turned off.

In contrast, if the predefined hard key 37 or any hard key 37 for cancelling the power saving function is operated, the power saving function is cancelled, and the CPU 100 turns on each backlight 11b, 21b.

As a function control module, the CPU 100 sets and cancels the key lock function according to the input information from the user or the information from the program.

For example, for cases in which processing that sets the key lock function is allocated to the icon displayed on each display surface or the hard key 37, if that icon or the hard key 37 is operated by the user, the CPU 100 sets the key lock function. For example, if the power key 36 is pressed for more than the predefined time, the CPU 100 may set the keylock function.

If the key lock function is set and the cancellation screen is displayed, the CPU 100 accepts (processes) the inputs with respect to the object image OI on the cancellation screen only among the inputs by the user output from each touch sensor. Therefore, any inputs besides the inputs with respect to the object image OI become invalid. The CPU 100 does not execute processing corresponding to the inputs besides the operation for cancelling the key lock function.

If each backlight is turned off in the state in which the key lock function is set, any inputs besides the inputs for turning on each backlight become invalid. Therefore, if the hard key 37 to which processing that turns on each backlight is allocated is operated, the CPU 100 executes processing and turns on each backlight. In the state in which each backlight is turned off, the cancellation screen is not displayed, thereby, making the inputs with respect to the object image OI on the cancellation screen invalid as well.

If the time elapsed since the input signals from each touch sensor 12, 22 and the key input circuit 303 disappear exceeds the predefined time, the key lock function may be set.

In contrast, if the display position P of the object image OI is moved to the display surface, which is different from the display surface on which the start position P0 of the object image OI is displayed, the CPU 100 cancels the key lock function. For example, for cases in which the start position P0 of the object image OI is displayed on the first display surface 11a1, as shown in FIG. 4A, if the display position P of the object image OI moves to the second display surface 21a1, as shown in FIG. 4B, the CPU 100 cancels the key lock function.

For example, if the user slides their finger touching the object image OI without releasing it from the start position P0 of the first display surface 11a1 to the second display surface 21a1, the position signals are output from the second touch sensor 22 in place of the first touch sensor 12. Accordingly, the CPU 100 determines that the display position P of the object image OI has moved from the first display surface 11a1 to the second display surface 21a1 by corresponding to the input position and cancels the keylock function.

If the user releases their finger touching the object image OI by means of a flick, the CPU 100 determines the moving distance C of the object image OI from the moving speed of the input position before the release, based on the manipulated variable-moving distance support information. The display position P of the object image OI is moved by the moving distance C only from the display position Pn at the time of release by means of this flick. The display coordinate system of the first display surface 11a1 and the display coordinate system of the second display surface 21a1 are common; therefore, the display position P (x, y) by means of the flick is determined from the display position Pn (xn, yn) and the moving distance C at the time of release.

Therefore, assuming that the distance in the X-axis direction of the moving distance C is Cx and the distance in the Y-axis direction is Cy, the display position P of the object image OI moved by means of the flick is displayed in the coordinate of (xn+Cx, yn+Cy). If the coordinate (xn+Cx, yn+Cy) of the display position P is within the range of the second display surface 21a1, the CPU 100 determines that the operation moving the object image OI to the second display surface 21a1 has been carried out by the user. The CPU 100 cancels the keylock function accordingly.

In this way, if the keylock function is cancelled, any inputs besides the operation for cancelling the keylock function are also accepted, and processing corresponding to the inputs is executed.

Note that the moving distance C of the object image OI and the display position P after the movement are determined when the finger is released by means of a flick. If the display position P is on the second display surface 21a1, the keylock function is cancelled and the cancellation screen is switched to the operation screen. Therefore, for cases in which the operation moving the object image OI to the second display surface 21a1 is carried out by means of a flick, if the time to switch from the cancellation screen to the operation screen is shorter compared to the time in which the object image OI moves to the second display surface 21a1, the CPU 100 may display the operation screen by cancelling the keylock function before the display position P of the object image OI reaches the second display surface 21a1.

If the operation to move the display position P of the object image OI to the second display surface 21a1 is carried out by means of a flick, it may not be necessary to display the fact that the object image OI has actually been moved to the second display surface 21a1.

<Processing Tasks of the First Embodiment>

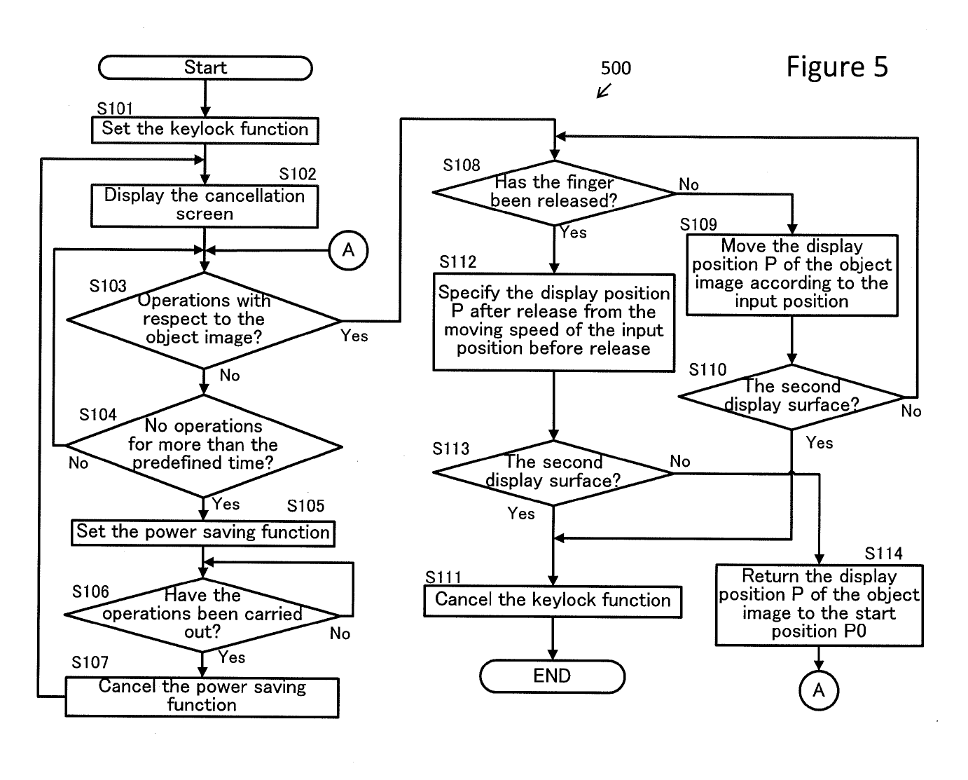

FIG. 4A is a diagram in which the cancellation screen in which the object image OI is disposed in the start position P0 is displayed on each display surface. FIG. 4B is a diagram in which the cancellation screen in which the object image OI is moved from the start position P0 to the display position P is displayed on each display surface. FIG. 5 is a flow chart showing the processing tasks in which the keylock function is cancelled if the operation is carried out such that the display position of the object image according to the embodiment is moved to the second display surface.

FIG. 5 is an illustration of a flowchart showing a process 500 in which the CPU 100 cancels the keylock function if the operation is carried out such that the display position P of the object image OI is moved to the second display surface 21a1 by means of the flick or the slide according to an embodiment. The various tasks performed in connection with the process 500 may be performed by software, hardware, firmware, a computer-readable medium having computer executable instructions for performing the process method, or any combination thereof. The process 500 may be recorded in a computer-readable medium such as a semiconductor memory, a magnetic disk, an optical disk, and the like, and can be accessed and executed, for example, by a computer CPU such as the CPU 100 in which the computer-readable medium is stored.

It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein. In practical embodiments, portions of the process 500a may be performed by different elements of the mobile phone 1 such as: the CPU 100, the memory 200, the touch sensor 12/22, etc. Process 500 may have functions, material, and structures that are similar to the embodiments shown in FIGS. 1-4. Therefore common features, functions, and elements may not be redundantly described here.

If the operation is not carried out with respect to each display surface 11a1, 21a1 and the hard keys 37 for the predefined time, the CPU 100 sets the key lock function (task S101).

If the key lock function is set, the cancellation screen is displayed on the first display surface 11a1 and the second display surface 21a1 (task S102). The object image OI on the cancellation screen is disposed in the start position P0.

The CPU 100 monitors whether or not the operation has been carried out with respect to the object image OI, based on the outputs from each touch sensor 12/22 (task S103). If the position signals are not output from the first touch sensor 12, or if the input position of the position signals output do not match the start position P0, the CPU 100 determines that the object image OI has not been touched by the user (task S103: NO).

In this way, if the state in which the position signals from the first touch sensor 12 do not match the start position P0 continues for more than the predefined time after the cancellation screen is displayed, the CPU 100 determines that the predefined time has elapsed without the object image OI being touched (task S104: YES). Accordingly, the CPU 100 sets the power saving function and turns off each display surface (task S105). Note that while each display surface is turned off, the operation with respect to each display surface 11a1, 21a1 is set as invalid.

If the hard keys 37 are pressed by the user, the CPU 100 determines that the operation has been carried out by the user (task S106: YES), cancels the power saving function, and displays the cancellation screen on each display surface (task S102). The key lock function is not cancelled even if the cancellation screen is displayed on each display surface; therefore, any inputs with respect to the object image OI are valid; however, the inputs with respect to the inputs besides this remain invalid.

If the input position of the position signals from the first touch sensor 12 matches the start position P0, the CPU 100 determines that the object image OI has been touched by the user (task S103: YES).

The CPU 100 monitors whether or not the finger touching the object image OI has been released from the first display surface 11a1 (task S108).

If the position signals are output from the first touch sensor 12, the CPU 100 determines that the finger touching the object image OI has not been released (task S108: NO). The finger slides on top of the first display surface 11a1 and, as a result, the CPU 100 moves the display position P of the object image OI according to the input position of the position signals (task S109). If the position signals are output from the second touch sensor 22 in place of the first touch sensor 12 to the CPU 100, the CPU 100 determines that the display position P of the object image OI has been moved to the second display surface 21a1 (task S110: YES). Accordingly, the CPU 100 cancels the key lock function and displays the operation screen on each display surface (task S111).

In contrast, if the position signals from the first touch sensor 12 are no longer output, the CPU 100 determines that the finger touching the object image OI has been released from the first display surface 11a1 by means of a flick (task S108: YES). The CPU 100 determines the moving speed of the object image OI and the moving distance C after release from the moving speed of the input position before release, based on the manipulated variable-moving distance support information.

The display position P of the object image OI is moved at the moving speed determined by means of the CPU 100. The CPU 100 determines the display position P from the display position Pn and the moving distance C at the time of the release (task S112). If the CPU 100 determines that the display position P of the object image OI is on the second display surface 21a1, it determines that the operation to move the object image OI to the second display surface 21a1 has been carried out (task S113: YES), and cancels the key lock function (task S111).

If the display position P of the object image OI is not on the second display surface 21a1 (task S113: NO), the display position P of the object image OI is returned to the start position P0 (task S114). The CPU 100 then re-monitors whether or not the object image OI has been touched (task S103).

As mentioned above, according to an embodiment, the key lock function is cancelled if the user carries out the operations to touch the object image OI, a flick or slide of the touched finger, and moves the object image OI to the second display surface 21a1. Cancellation of the key lock function is determined according to a series of actions by the user as described above; thereby, making it possible to prevent situations of malfunctions caused by cancellation of the key lock function by means of inputs not intended by the user.

### Second Embodiment

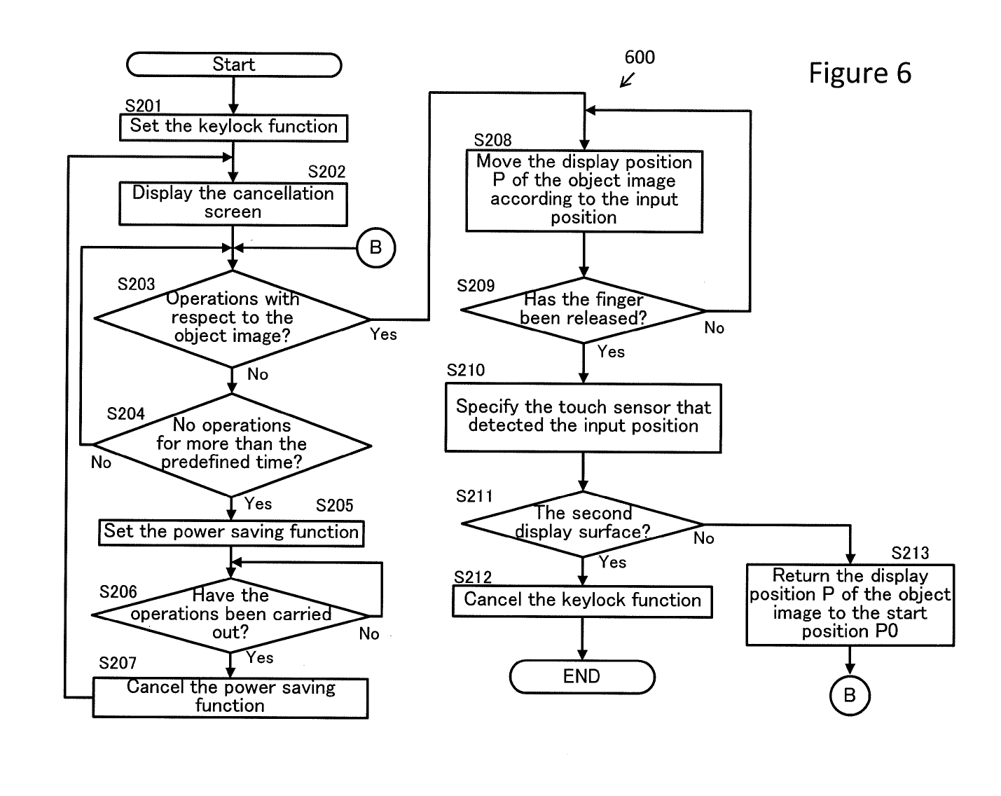

In FIG. 5, the key lock function is cancelled if the operation moving the display position P of the object image OI to the second display surface 21a1 is carried out by means of a flick or slide. In contrast, in FIG. 6, the CPU 100 cancels the key lock function if the display position P of the object image OI moved by means of a slide is on the second display surface 21a1 at the time of release.

In FIG. 5, the input position from when the object image OI is touched by the user is temporarily stored in the memory 200. In FIG. 6, in addition to the input position, identification information of the touch sensor outputting the position signals according to the input position to the CPU 100 is temporarily stored in the memory 200. Therefore, the identification information of the touch sensor outputting the position signals according to the input position before release is read from the memory 200 after the finger touching the object image OI is released. If the identification information is the first touch sensor 12, the CPU 100 determines the input position as the first display surface 11a1, and if the identification information is the second touch sensor 22, it determines the input position as the second display surface 21a1.

FIG. 6 is an illustration of a flowchart showing a process 600 in which the key lock function is cancelled if the display position of the object image at the time of release is on the second display surface according to an embodiment. Specifically, FIG. 6 is a flow chart showing the processing tasks in which the key lock function is cancelled by the CPU 100 if display position P of the object image OI at the time of the release is on the second display surface 21a1.

The various tasks performed in connection with the process 600 may be performed by software, hardware, firmware, a computer-readable medium having computer executable instructions for performing the process method, or any combination thereof. The process 600 may be recorded in a computer-readable medium such as a semiconductor memory, a magnetic disk, an optical disk, and the like, and can be accessed and executed, for example, by a computer CPU such as the CPU 100 in which the computer-readable medium is stored.

It should be appreciated that process 600 may include any number of additional or alternative tasks, the tasks shown in FIG. 6 need not be performed in the illustrated order, and process 600 may be incorporated into a more comprehensive procedure or process having additional functionality not described in detail herein. In practical embodiments, portions of the process 600 may be performed by different elements of the mobile phone 1 such as: the CPU 100, the memory 200, the touch sensor 12/22, etc. Process 600 may have functions, material, and structures that are similar to the embodiments shown in FIGS. 1-5. Therefore common features, functions, and elements may not be redundantly described here. Task S201 to task S207 are similar to task S101 to task S107 in FIG. 5 respectively; therefore, task S201 to task S207 may not be redundantly described here.

If the object image OI is touched by the user (task S203: YES), the display position P of the object image OI is moved by following the input position (task S208).

The CPU 100 monitors whether or not the user has released their finger touching the object (task S209). If the first touch sensor 12 and the second touch sensor 22 no longer detect the input position, the CPU 100 determines that the finger has been released from each display surface (task S209: YES).

The CPU 100 reads out the input position immediately before release as well as the identification information of the touch sensor that detected the input position from the memory 200, and specifies the touch sensor that detected the input position from the identification information (task S210).

The input position corresponds to the display position P of the object image OI; therefore, the CPU 100 determines the display surface on which the object image OI is displayed from the identification information of the touch sensor that detected the input position (task S211).

If the identification information is the first touch sensor 12, the CPU 100 determines that the display position P of the object image OI at the time of release has been moved to the second display surface 21a1 (task S211: YES). The CPU 100 cancels the key lock function accordingly (task S212). The CPU 100 displays the operation screen on each display surface, making it possible to use the mobile phone 1.

In contrast, if the identification information is the second touch sensor 22, the CPU 100 determines at the time of the release that that the display position P of the object image OI is the first display surface 11a1 (task S211: NO). The CPU 100 returns the display position P of the object image OI to the start position P0 (task S213). The CPU 100 monitors whether or not the object image OI has been touched (task S203).

As above, according to the present embodiment, the key lock function is cancelled if the display position P of the object image OI is moved to the second display surface 21a1 at the time the user releases their finger touching the object image OI from each display surface 11a1, 21a1. In this way, cancellation of the key lock function is determined from the display position P of the object image OI at the time of release; therefore, cases in which the key lock function is cancelled when the display position P reaches the second display surface 21a1 accidentally and the like, are eliminated. Consequently, malfunctions may be prevented in accordance with the intention by the user.

### Third Embodiment

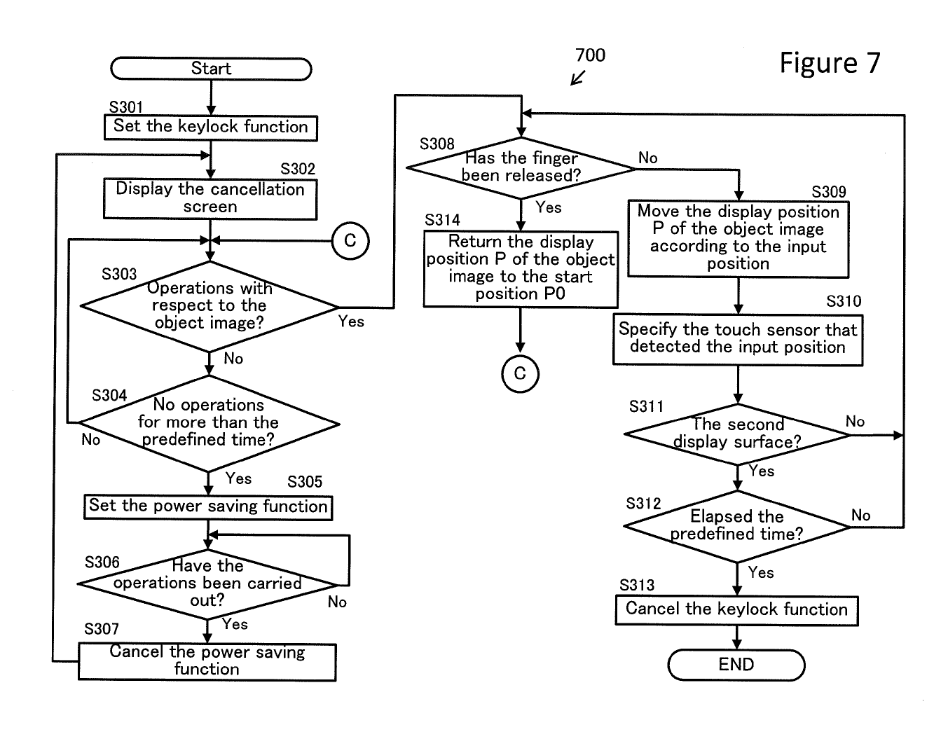

In FIG. 6, the CPU 100 cancels the key lock function if the display position P of the object image OI moved by means of a slide is on the second display surface 21a1 at the time of release. In contrast, in FIG. 7, the CPU 100 cancels the key lock function if the display position P of the object image OI moved by means of a slide is on the second display surface 21a1 for the predefined time.

FIG. 7 an illustration of a flowchart showing a process 700 in which the key lock function is cancelled if the display region of the object image is on the second display surface for more than the predefined time according to an embodiment. Specifically, FIG. 7 is a flowchart showing the process 700 in which the CPU 100 cancels the key lock function if the display position P of the object image OI is on the second display surface 21a1 for the predefined time.

The various tasks performed in connection with the process 700 may be performed by software, hardware, firmware, a computer-readable medium having computer executable instructions for performing the process method, or any combination thereof. The process 700 may be recorded in a computer-readable medium such as a semiconductor memory, a magnetic disk, an optical disk, and the like, and can be accessed and executed, for example, by a computer CPU such as the CPU 100 in which the computer-readable medium is stored.

It should be appreciated that process 700 may include any number of additional or alternative tasks, the tasks shown in FIG. 7 need not be performed in the illustrated order, and process 700 may be incorporated into a more comprehensive procedure or process having additional functionality not described in detail herein. In practical embodiments, portions of the process 700 may be performed by different elements of the mobile phone 1 such as: the CPU 100, the memory 200, the touch sensor 12/22, etc.

Process 700 may have functions, material, and structures that are similar to the embodiments shown in FIGS. 1-6. Therefore common features, functions, and elements may not be redundantly described here. Task S301 to task S307 are similar to processing at task S101 to task S107, respectively; therefore, task S301 to task S307 may not be redundantly described here.

The object image OI is moved corresponding to the input position (task S309) since the user touches their finger with respect to the object image OI (task S303: NO) until the user releases their finger touching the object image OI from the display surface (task S308: NO).

While the display position P of the object image OI moves according to the input position, the CPU 100 monitors the touch sensor detecting the input position (task S310).

If the position signals corresponding to the input position are output from the first touch sensor 12 to the CPU 100, the CPU 100 determines that the object image OI is displayed on the first display surface 11a1 (task S311: NO). The display position P of the object image is not moved to the second display surface 21a1; therefore, the object image OI is moved corresponding to the input position while the finger is not released (task S308, task S309).

In contrast, if the position signals corresponding to the input position are output from the second touch sensor 12 to the CPU 100, the CPU 100 determines that the object image OI is displayed on the second display surface 21a1 (task S311: YES).

The CPU 100 measures the time elapsed from when the object image OI is moved to the second display surface 21a1, using the clock 311. While the measured time does not exceed the predefined time (task S312: NO), the CPU 100 monitors whether or not the display position P of the object image OI is on the second display surface 21a1 (task S308, task S309, task S310, task S311: YES). While the object image OI is positioned within the region of the second display surface 21a1, the CPU 100 continues measuring the elapsed time.

If the measured time exceeds the predefined time (task S312: YES), the CPU 100 determines that the object image OI is within the region of the second display surface 21a1 for more than the predefined time. The CPU 100 cancels the key lock function (task S313).

If the finger touching the object image OI is released (task S308: YES), the display position P of the object image OI returns to the start position P0 (task S314). The CPU 100 executes the processing of TASK S303.

As above, according to the present embodiment, the key lock function is cancelled if the user moves the object image OI to the second display surface 21a1 and maintains such that the object image OI does not leave the second display surface 21a1. In this way, cancellation of the key lock function is determined by means of the operation that continues the state in which the object image OI is present on the second display surface 21a1; therefore, cases in which the key lock function is cancelled after the display position P reaches the second display surface 21a1 accidentally and the like, are eliminated, preventing malfunctions.

### Fourth Embodiment

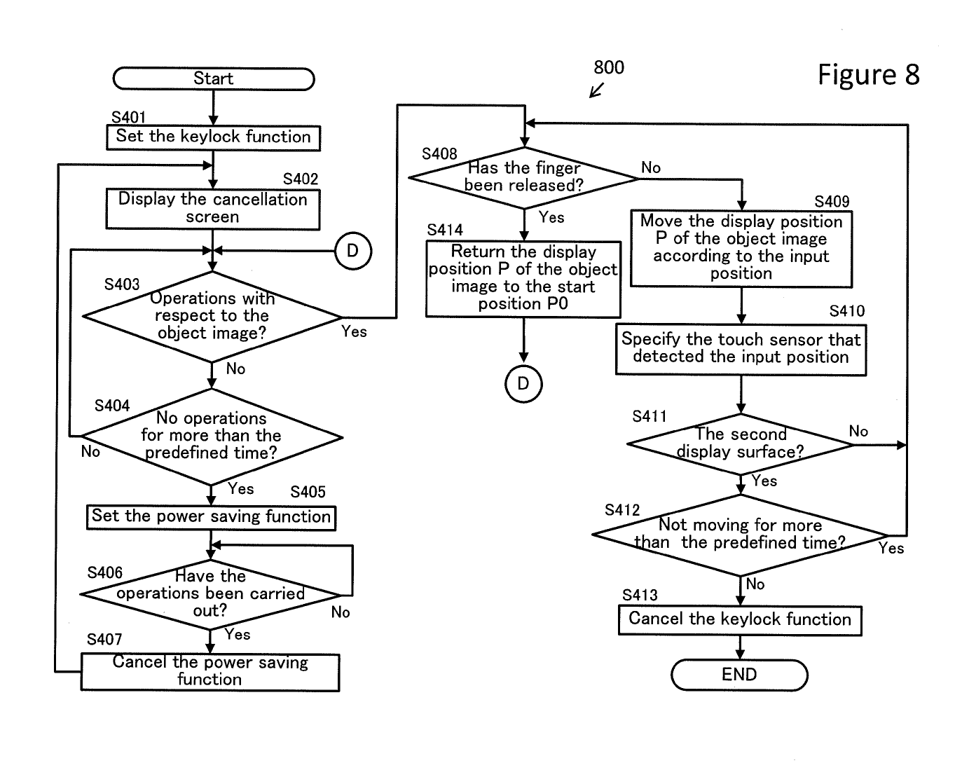

In FIG. 7, the keylock function is cancelled if the display position P of the object image OI is on the second display surface 21a1 continuously during the predefined time. In contrast, in FIG. 8, if the display position P of the object image OI is in the same position within the region of the second display surface 21a1 continuously for the predefined time, the CPU 100 cancels the keylock function. Note that not only may the same position comprise the spot in which the object image OI is stopped, it may also comprise the predefined region from the spot in which it is stopped.

FIG. 8 is a flowchart showing a process 800 in which the keylock function is cancelled if the display region of the object image according to the embodiment is in the same position on the second display surface for more than the predefined time. Specifically, FIG. 8 is a flowchart showing a process 800 in which the keylock function is cancelled if the display position P of the object image OI does not move from the position on the second display surface 21a1 for the predefined time.

The various tasks performed in connection with the process 800 may be performed by software, hardware, firmware, a computer-readable medium having computer executable instructions for performing the process method, or any combination thereof. The process 800 may be recorded in a computer-readable medium such as a semiconductor memory, a magnetic disk, an optical disk, and the like, and can be accessed and executed, for example, by a computer CPU such as the CPU 100 in which the computer-readable medium is stored.

It should be appreciated that process 800 may include any number of additional or alternative tasks, the tasks shown in FIG. 8 need not be performed in the illustrated order, and process 800 may be incorporated into a more comprehensive procedure or process having additional functionality not described in detail herein. In practical embodiments, portions of the process 800 may be performed by different elements of the mobile phone 1 such as: the CPU 100, the memory 200, the touch sensor 12/22, etc.

Process 800 may have functions, material, and structures that are similar to the embodiments shown in FIGS. 1-7. Therefore common features, functions, and elements may not be redundantly described here. Task S401 to task S407 are similar to task S101 to task S107, respectively, and task S408 to task S411, task S413 and task S414 are similar to task S308 to task S311, task S313 and task S314, therefore, task S408 to task S411, and task S413 and task S414 may not be redundantly described here.

If the display position P of the object image OI is moved to the second display surface 21a1 (task S411: YES), the CPU 100 is monitored for whether or not the finger touching the object image OI has been released, and whether or not the object image OI is present within the region of the second display surface 21a1 (task S408, task S411). If the finger is touched by the object image OI and the object image OI is present on the second display surface 21a1 (task S408: NO, task S411: YES), the CPU 100 monitors the display position P of the object image OI (task S412).

If the display position P of the object image OI moves within the region of the second display surface 21a1, the CPU 100 starts measuring the time. If the display position P changes again, the time is measured again after the measured time is reset.

If the input position output for each predefined time changes, the CPU 100 may reset the measured time. If the object image OI stops moving, it continues measuring the time. If the input position output for each predefined time does not change, the CPU 100 may continue measuring the time. If the input position output for each predefined time is within the predefined range from the display position P after starting the measurement, the CPU 100 may continue measuring the time. If the measured time exceeds the elapsed time, the CPU 100 determines that the object image OI is not moving for more than the predefined time (task S412: No). The CPU 100 cancels the key lock function (task S413).

As above, according to the present embodiment, the key lock function is cancelled if the user moves the object image OI to the second display surface 21a1 and stops the object image OI in the same position on the second display surface 21a1 continuously for more than the predefined time. In this way, cases in which the key lock function is cancelled when the display position P reaches the second display surface 21a1 accidentally and the like, are eliminated, preventing malfunctions.

### Other Embodiments

In the above embodiments, the display surface displaying the object image OI by means of the identification information of the touch sensor that detected the input position was determined. In an embodiment, the display surface displaying the object image OI from either the input position or the display position of the object image OI may also be determined.

In the above embodiments, the CPU 100 canceled the key lock function by moving the object image from the first display surface 11a1 to the second display surface 21a1. In an embodiment, the key lock function may be cancelled by moving the object image from the second display surface 21a1 to the first display surface 11a1.

In the above embodiments, the circular object image OI was displayed on the cancellation screen of the key lock function; however, other cancellation screens may also be used as explained below.

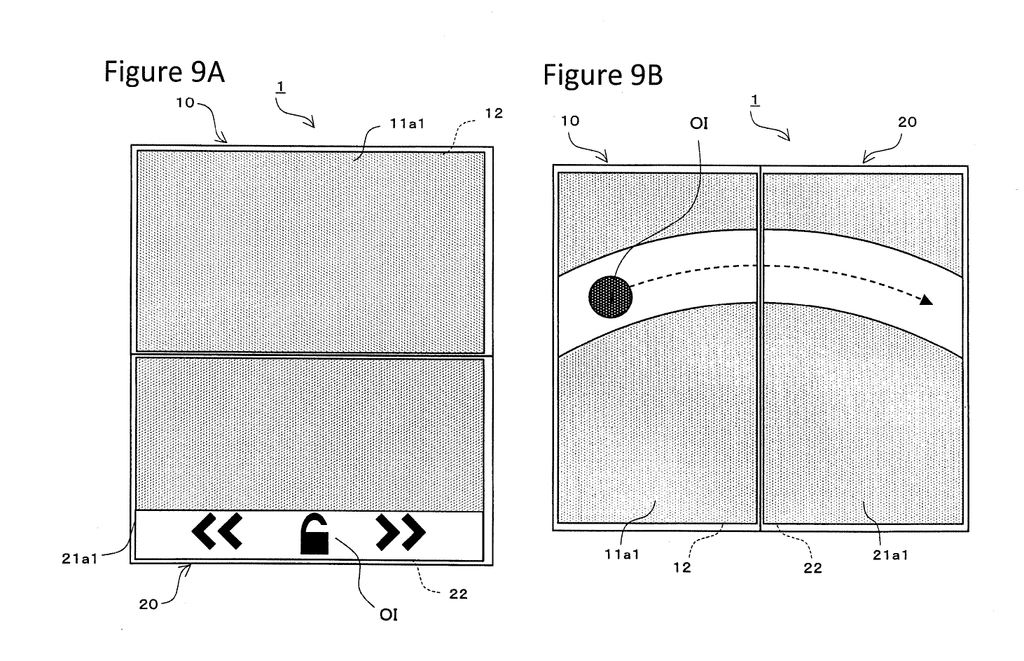

FIG. 9 is a diagram displaying the cancellation screen on each display surface. For example, on the cancellation screen, a rectangular object image OI comprising a key and arrows is displayed in the start position at the edge of the first display surface 11a1. If this object image OI is touched and moved to the second display surface 21a1, the CPU 100 may cancel the key lock function.

On the cancellation screen, the circular object image OI is displayed on top of an arc-shaped path. If this object image OI is touched and moved from the first display surface 11a1 to the second display surface 21a1 along the path, the key lock function may be cancelled.

On the cancellation screen, a key shaped object image OI and a lock shaped image are displayed on top of the rectangular path, and the key shaped object image OI is displayed on the first display surface 11a1 and the lock shaped image is displayed on the second display surface 21a1. If the key shaped object image OI is touched and moved to the lock shaped image along the path, the key lock function may be cancelled.

A triangular object image OI that looks as if the corners of the image have been folded is displayed on the cancellation screen. If this object image OI is moved from the first display surface 11a1 to the second display surface 21a1, the key lock function may be cancelled. In this example, it may be displayed as if the folded module spreads out as the object image OI moves.

An arc shaped object image OI in which predefined letters such as “locked” are indicated is shown on the cancellation screen. If this object image OI is touched and moved from the first display surface 11a1 to the second display surface 21a1, the key lock function may be cancelled.

In the present embodiment, if the operation moving the object image OI is not carried out for more than the predefined time continuously after the object image OI is touched by the finger, the CPU 100 may set the power saving function after storing the input position as well as the identification information of the touch sensor detecting the input position. The power saving function turns off each backlight. While the first backlight 11b and the second backlight 21b are turned off, the key lock function is executed. Each backlight is turned off. While the first backlight 11b and the second backlight 21b are turned off, the inputs with respect to the first display surface 11a1 and the second display surface 21a1 are set as invalid.

If the predefined hard key 37 for cancelling the power saving function is operated, the power saving function is canceled, turning on the first backlight 11b and the second backlight 21b. The CPU 100 may read the input position before executing the power saving function from the memory 200 and display the cancellation screen in which the object image OI is disposed in that input position on the first display surface 11a1 and the second display surface 21a1. The CPU 100 reads out the identification information of the touch sensor from the memory 200. If the identification information indicates the second touch sensor 22, the CPU 100 cancels the key lock function. In contrast, if the identification information indicates the first touch sensor 12, the CPU 100 moves the object image OI from the display position P to the start position P0 on the cancellation screen in the state in which the key lock function is maintained.

Accordingly, even if the power saving function and the like, is not executed while the operation that cancels the key lock function is carried out, it is determined by means of the operation content before cancellation of the power saving function; consequently, it is not necessary to carry out the operation again, potentially resulting in excellent convenience.

In the present embodiment, the power saving function may be set if the operation moving the object image OI is not carried out continuously for more than the predefined time after the object image OI is touched by the finger. The power saving function turns off the first backlight 11b and the second backlight 21b and the inputs with respect to the first display surface 11a1 and the second display surface 21a1 are set as invalid. If the predefined or any hard key 37 for cancelling the power saving function is operated, the first display surface 11a1 and the second display surface 21a1 are turned on, and the cancellation screen is displayed on the first display surface 11a1 and the second display surface 21a1. At this time, the object image OI is disposed in the object image OI on the cancellation screen.

In the present embodiment, if the display position P of the object image OI does not reach the second display surface 21a1, the display position P of the object image OI is returned to the start position P0. At this time, comments for guiding the object image OI to move more quickly may be displayed on each display surface.

In the present embodiment, if the power saving function is set, each backlight is turned off; however, the CPU 100 may lower the brightness without turning off each backlight. In such cases, the CPU 100 increases the brightness of each backlight if the power saving function is cancelled.

In the present embodiment, the key lock function may switch between setting and cancelling of the key lock function by switching the state of the mobile phone 1. For example, for cases in which the key lock function is set, if the state of the mobile phone 1 is switched from the closed state to the open state, the key lock function may be cancelled. In this way, the user can cancel the key lock function by means of the operation that switches the state of the mobile phone 1; therefore, it is not necessary to carry out the operation for cancelling the key lock function, potentially resulting in excellent operability.

In the present embodiment, while the operation moving the object image OI on the cancellation screen is carried out, there may be incoming calls, or an alarm function may be started. In such cases, the CPU 100 may display the screen corresponding to the incoming call or alarm, in place of the cancellation screen, on the first display surface 11a1 and the second display surface 21a1 and set the inputs with respect to each screen as valid.

The CPU 100 may display the screen corresponding to the incoming call or alarm, in place of the cancellation screen, on the first display surface 11a1 and the second display surface 21a1 rather than setting the inputs with respect to each screen as valid, and cancel the key lock function temporarily. In this way, for cases requiring an immediate response such as an incoming call or alarm, the screen of that function is displayed, making the operation with respect to that function possible and resulting in excellent convenience.

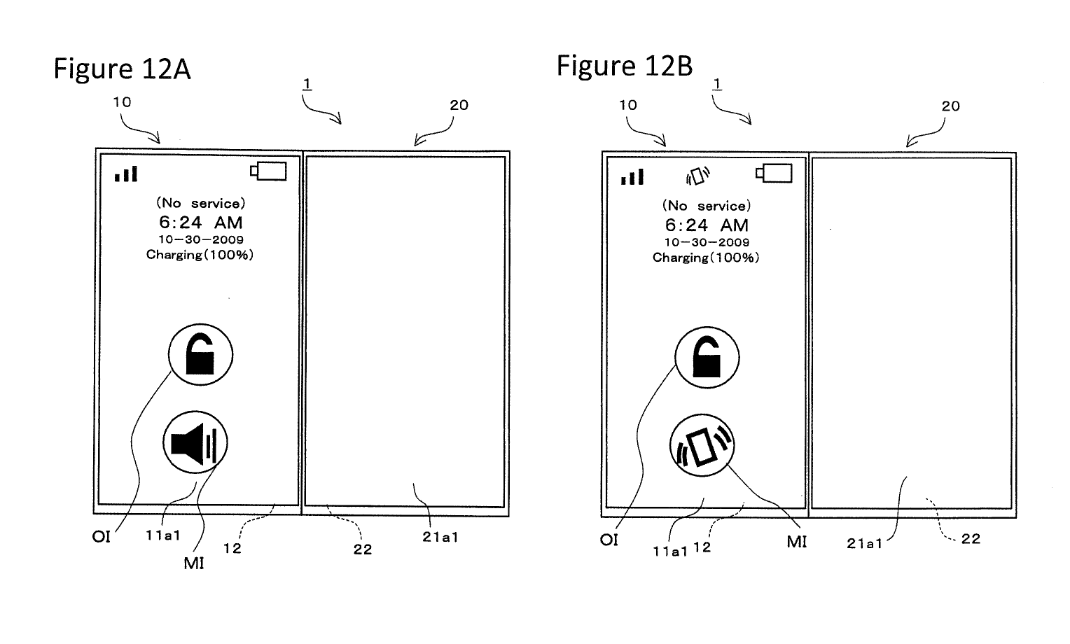

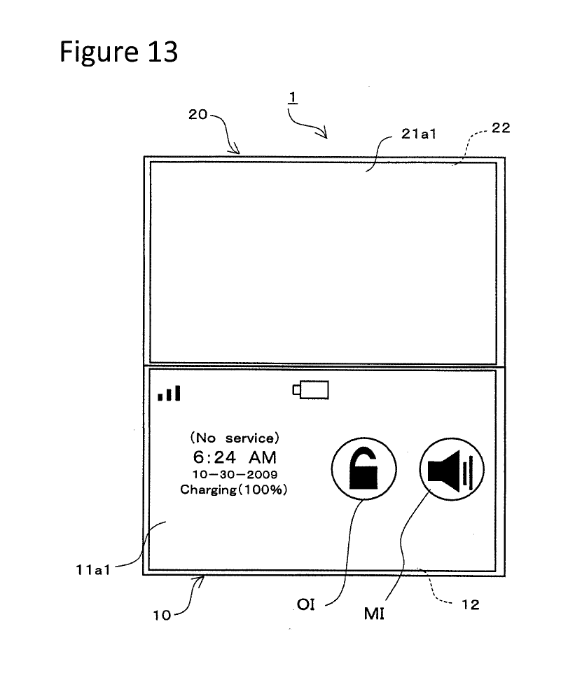

In the present embodiment, it may be possible to switch the silent mode on the cancellation screen. FIG. 12 is a diagram displaying the cancellation screen according to the embodiment on each display surface of the mobile phone in the portrait orientation. FIG. 13 is a diagram displaying the cancellation screen according to the embodiment on each display surface of the mobile phone in landscape orientation. As shown in FIG. 12 and FIG. 13, the CPU 100 displays a switching image MI that sets or cancels the silent mode on the cancellation screen. The switching image MI is equivalent to the object image for switching a notification means and is different from the object image OI for cancelling the key lock function.

The notification means comprises notification by means of sound and notification by means of vibration. If the silent mode is set, the CPU 100 sets notification by means of vibration. If the silent mode is cancelled, the CPU 100 executes notification by means of sound.

For example, in addition to the object image OI, the switching image MI of the silent mode is also displayed on the cancellation screen. If the silent mode is not set, the switching image M1 indicates that sound is output from the speaker 38 as the notification means such as an incoming call or alarm, as shown in FIG. 12A. In contrast, if the silent mode is set, the switching image M1 indicates that it vibrates by means of the notification means such as an incoming all or alarm as shown in FIG. 12B.

As is the case with cancellation of the key lock function, if the switching image MI is moved from the first display surface 11a1 to the second display surface 21a1 by means of the operation by the user, the CPU 100 executes setting or cancelling of the silent mode and switches the notification means. For example, for states in which the silent mode is not set, if the switching image MI is moved from the first display surface 11a1 to the second display surface 21a1, the CPU 100 sets the silent mode and displays the screen shown in FIG. 12B, in place of the screen shown in FIG. 12A. In this way, as the switching image MI is switched, the user may learn that the notification by means of sound has been switched to the notification by means of vibration.

If the switching image MI moves from the first display surface 11a1 to the second display surface 21a1, the CPU 100 cancels the silent mode. In this case, the silent mode is cancelled; however, the key lock function is maintained; therefore, the cancellation screen in FIG. 12B remains displayed on each display surface. If the switching image MI is moved from the first display surface 11a1 to the second display surface 21a1, the CPU 100 may cancel the silent mode in addition to cancelling the key lock function. Accordingly, the operation screen, in place of the cancellation screen, is displayed on each display surface.

If the orientation of the mobile phone 1 is changed from the portrait orientation (the first direction) to the landscape orientation (the second direction), the disposition or the display direction of the object image OI, the switching image MI and the like, on the cancellation screen may be switched. When the orientation of the mobile phone 1 changes, the CPU 100 may dispose the object image OI and the switching image MI on the second display surface 21a1.

While the switching image MI is operated, the CPU 100 may display the object image OI as semitransparent. While the object image OI is operated, the CPU 100 may display the switching image MI as semitransparent. The user may be able to identify whether or not one of the switching image MI or the object image OI is being operated.

The mobile phone 1 according to the present embodiment may comprise three or more touch panels.

In this document, the terms “computer program product”, “computer-readable medium”, and the like may be used generally to refer to media such as, for example, memory, storage devices, or storage unit. These and other forms of computer-readable media may be involved in storing one or more instructions for use by the CPU 100 to cause the CPU 100 to perform specified operations. Such instructions, generally referred to as “computer program code” or “program code” (which may be grouped in the form of computer programs or other groupings), when executed, enable a method of using a system such as the mobile phone 1.

Terms and phrases used in this document, and variations hereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile electronic device, comprising:
a first display module comprising a first detection module which operable to detect a first input by a user;
a second display module comprising a second detection module which operable to detect a second input by a user;
a display control module operable to:
display a cancellation screen comprising a first object image for cancelling a key lock function, the first object image displayed on the first display module; and
move a first image position of the first object image in response to one of the first input and the second input; and
a function control module operable to:
control a setting and a cancellation of the key lock function that sets the first input and the second input to invalid inputs;
cancel the key lock function, if the display module moves the first image position from the first display module to the second display module.

2. The mobile electronic device according to claim 1, wherein the function control module is further operable to cancel the key lock function, if a input for moving the first image position is not detected and if the first image position is on the second display module, the input for moving the first image position comprising the first input and the second input.

3. The mobile electronic device according to claim 1, wherein the function control module is further operable to cancel the key lock function, if the first object image is on the second display module for a predefined time after the first image position is moved from the first display module to the second display module.

4. The mobile electronic device according to claim 1, wherein the function control module is further operable to cancel the key lock function if the first object image is in a predefined area inside the second display module for a predefined time after the first image position is moved from the first display to the first display module.

5. The mobile electronic device according to claim 4, further comprising a storage module operable to store the first image position if a input for moving the first image position is not detected for a predefined time after the first image position is moved, wherein:
the display control module is further operable to turn off the first display module and the second display module if the input for moving the first image position is not detected for a predefined time after the first image position is moved.

6. The mobile electronic device according to claim 5, wherein:
the first detection module and the second detection module are further operable to not detect the first input and second input respectively, if the first display module and the second display module are turned off.

7. The mobile electronic device according to claim 6, further comprising:
a third input module operable to accept a third input by a user, wherein:
the display control module is further operable to:
turn on the first display module and the second display module, if the third input module accepts the third input by a user, and
display the cancellation screen on which the first object image is disposed at the first image position stored in the storage module.

8. The mobile electronic device according to claim 7, wherein the function control module is operable to cancel the keylock function, if the first display module and the second display module are turned on and if the first image position stored in the storage module is on the second display module.

9. The mobile electronic device according to claim 7, wherein:
the cancellation screen comprises a second object image, which is different from the first object image;
the display control module is further operable to move a second object position of the second object image according to one of the first input and the second input; and
a notification control module is operable to switch a notification method, if the display control module moves the second object position from the first display module to the second display module.

10. The mobile electronic device according to claim 9, wherein:
the notification control module is further operable to:
generate a notification by means of one of sound and vibration; and
switch the notification by one of the sound and vibration, if the second object position is moved from the first display module to the second display module.

11. A method for controlling a mobile electronic device, the method comprising:
detecting a first input and a second input on a first display module and a second display module respectively;
displaying a cancellation screen comprising a first object image for cancelling a key lock function that sets the first input and the second input to invalid inputs, the first object displayed on the first display;
moving a position of the first object image in response to one of the first input and the second input;
cancelling the key lock function, if the first image position of the first object image is moved from the first display module to the second display module.

12. A computer readable storage medium comprising computer-executable instructions for operating a mobile electronic device, the method executed by the computer-executable instructions comprising:
detecting a first input and a second input on a first display module and a second display module respectively;
displaying a cancellation screen comprising a first object image for cancelling a key lock function that sets the first input and the second input to invalid inputs, the first object image displayed on the first screen;
moving a position of the first object image in response to one of the first input and the second input;
cancelling the key lock function, if the first image position of the first object image is moved from the first display module to the second display module.
